(19) United States
(12) Patent Application Publication
(10) Pub. No.: US 2026/0127097 A1
(43) Pub. Date: May 7, 2026

(54) AUTOMATED TEST AND TEST CASE DESCRIPTION GENERATION FOR END-TO-END PROCESSES

(71) Applicant: SAP SE, Walldorf (DE)

(72) Inventor: Sebastian Mietke, Reilingen (DE)

(21) Appl. No.: 18/936,347

(22) Filed: Nov. 4, 2024

(51) Int. Cl. G06F 11/36

(52) U.S. Cl. CPC G06F 11/368; G06F 11/3688

(57) ABSTRACT

One or more first actions and one or more first checks performed during testing of first functionality of a first version of a first software application are detected. Next, the one or more first actions and one or more first checks are translated into a first set of source code. Then, a first script is generated with the first set of source code. Next, testing is performed of the first functionality of a second version of the first software application by executing the first script. Then, usage of the second version of the first software application on a first cloud platform is enabled in response to completing the testing of the first functionality of the second version of the first software application.

### TECHNICAL FIELD

The present disclosure generally relates to generating manual test case descriptions and automated tests for end-to-end processes.

### BACKGROUND

An application can be hosted by a cloud platform such that the application can be remotely accessible to multiple tenants, for example, over the Internet. For example, the application can be available as a cloud-based service including, for example, a software as a service (SaaS) and/or the like. Many organizations rely on such cloud-based enterprise software applications including, for example, enterprise resource planning (ERP) software, customer relationship management (CRM) software, and/or the like. These enterprise software applications may provide a variety of functionalities including, for example, invoicing, procurement, payroll, time and attendance management, recruiting and onboarding, learning and development, performance and compensation, workforce planning, and/or the like. Testing the functionality of various software applications may require significant effort on the part of developers and testers. Accordingly, improved methods and mechanisms for testing the functionality of software applications are desired.

### SUMMARY

In some implementations, one or more first actions and one or more first checks performed during testing of first functionality of a first version of a first software application are detected. Next, the one or more first actions and one or more first checks are translated into a first set of source code. Then, a first script is generated with the first set of source code. Next, testing is performed of the first functionality of a second version of the first software application by executing the first script. Then, usage of the second version of the first software application on a first cloud platform is enabled in response to completing the testing of the first functionality of the second version of the first software application.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a logical diagram of an example of a system, in accordance with some example implementations of the current subject matter;

FIG. 2 illustrates a logical block diagram of a computing system, in accordance with some example implementations of the current subject matter;

FIG. 3 illustrates a block diagram of test generation and automated test execution functionality, in accordance with some example implementations of the current subject matter;

FIG. 4 illustrates example of tables with check information collected by a check condition generation component, in accordance with some example implementations of the current subject matter;

FIG. 5 illustrates an example of pseudocode generated by a check condition translation component, in accordance with some example implementations of the current subject matter;

FIG. 6 illustrates examples of a technical source code snippet and corresponding human readable text, in accordance with some example implementations of the current subject matter;

FIG. 7 illustrates an example of a table with a list of steps and checks to be performed during the execution of an end-to-end test, in accordance with some example implementations of the current subject matter;

FIG. 8 illustrates a process for automatic test generation, in accordance with some example implementations of the current subject matter;

FIG. 9 illustrates a process for automated test staging, in accordance with some example implementations of the current subject matter;

FIG. 10 illustrates a process for enabling automatic testing of functionality of a software application, in accordance with some example implementations of the current subject matter;

FIG. 11A depicts an example of a system, in accordance with some example implementations of the current subject matter; and

FIG. 11B depicts another example of a system, in accordance with some example implementations of the current subject matter.

### DETAILED DESCRIPTION

End-to-end tests are essential to ensure the correct functionality of software products. These tests cover complete processes starting from the frontend (typically a user interface). The tests can be performed manually and/or automatically. A lot of effort might be spent during testing to create the corresponding test artifacts. Not only should the test reproduce the defined process steps, but one or more meaningful checks should also be performed after each process step, to achieve a high quality of the test. Therefore, a test step consists of an action and a corresponding check.

If the test should be performed automatically, technical code may be developed, which can be interpreted by the test environment. In general, manual effort is required to create meaningful assertions after each process step. If the test should be performed manually, a human readable document may be created, which contains relevant information to execute the complete process and to perform the checks. The description should be understandable by the tester. The tester might be more or less familiar with the software product under test. Therefore, plenty of details should be added to the description. Unfortunately, the quality of the manually written automated tests as well as the manually written test case descriptions for manual processing is often lacking. In both cases, important checks might be missing. The description might be difficult for the tester to understand.

In various embodiments, the creation of test artifacts for end-to-end tests can be automated to a high degree. A new functionality may be provided, to create the test artifacts easily, even for users without a technical background. The proposed solution is capable of providing test scripts and test code for automatic processing as well as test case descriptions for manual processing.

Regarding web-based applications, this new functionality may be delivered as browser plugin. This new plugin provides simple selection tools, to mark user interface (UI) elements as check-relevant. The process under test may be executed manually by the user once in the UI to generate the test artifacts. After each process step, the user can select check-relevant UI elements and also enter some additional details, if required. Based on the users input, check-conditions are derived. These check-conditions are translated into technical source code fragments, to be used in automated tests. The check conditions may also be translated into human readable text fragments, to be used for manual testing. Finally, a complete automated test may be generated, which can be executed by the test environment. Additionally, a detailed, human readable and easily understandable test case description is generated, with the help of artificial intelligence (AI), for manual execution.

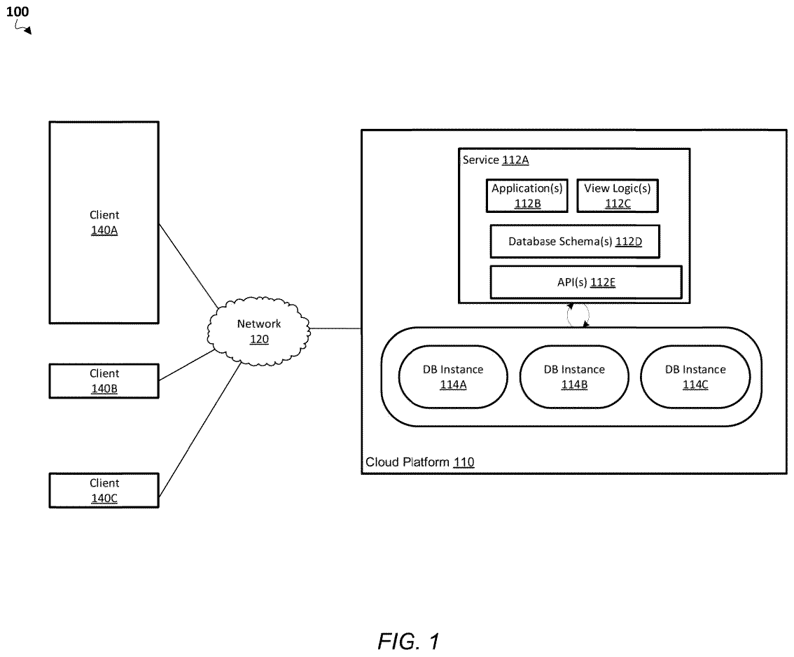

FIG. 1 depicts a diagram illustrating an example of a system 100 consistent with some implementations of the current subject matter. Referring to FIG. 1, the system 100 may include a cloud platform 110. The cloud platform 110 may provide resources that can be shared among a plurality of tenants. For example, the cloud platform 110 may be configured to provide a variety of services including, for example, software-as-a-service (SaaS), platform-as-a-service (PaaS), infrastructure as a service (IaaS), database as a service (DaaS), and/or the like, and these services can be accessed, via network 120, by one or more tenants of the cloud platform 110. Network 120 may be any wired and/or wireless network including, for example, a public land mobile network (PLMN), a wide area network (WAN), a local area network (LAN), a virtual local area network (VLAN), the Internet, and/or the like.

In the example of FIG. 1, the system 100 includes a first tenant 140A (labeled client), a second tenant 140B, and a third tenant 140C, although cloud platform 110 may have other quantities of tenants. The clients may each comprise a user device (e.g., a computer including an application such as a browser or other type of application). The user device may be a processor-based device including, for example, a smartphone, a tablet computer, a wearable apparatus, a virtual assistant, an Internet-of-Things (IoT) appliance, and/or the like. Each client may access, via network 120, at least one of the services at the cloud platform 110. In some implementations, each of the tenants 140A-C represents a separate tenant at the cloud platform 110, such that a tenant's data is not shared with other tenants (absent permission from a tenant). Alternatively, each of the tenants 140A-C may represent a single tenant at the cloud platform 110, such that the tenants do share a portion of the tenant's data, for example.

The cloud platform 110 may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources). In the case of a “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110 includes a service 112A, which is provided to the client 140A. This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client 140A). To illustrate further, client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110.

The service 112A may also include an application programming interface (API) 112E to the database layer, such as the database instance 114A and the like. The API 112E may be implemented as an Open Data Protocol (OData) interface (e.g., HTTP message may be used to create a query to a resource identified via a URI), although the API 112E may be implemented with other types of protocols including those in accordance with REST (Representational state transfer). In the example of FIG. 1, the database instance 114A may be accessed as a service at a cloud platform, which may be the same or different platform from cloud platform 110. In the case of REST compliant interfaces, the API 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110. Although the database instances are depicted at the same cloud platform 110, one or more of the database instances may be hosted on another or separate platform (e.g., on-premise) and/or another cloud platform.

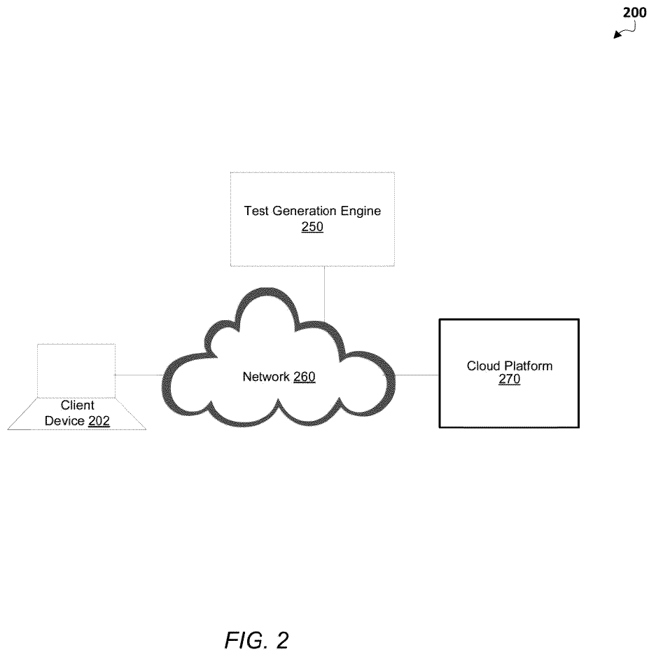

Turning now to FIG. 2, a system diagram illustrating an example of a computing system 200 is shown, in accordance with one or more embodiments of the current subject matter. Referring to FIG. 2, the computing system 200 may include one or more client devices 202, a test generation engine 250, and one or more cloud platforms 270. As shown in FIG. 2, the one or more client devices 202, the test generation engine 250, and the one or more cloud platforms 270 may be communicatively coupled via a network 260. The one or more cloud platforms 270 may include hybrid cloud platforms, on-premise cloud platforms, and/or off-premise cloud platforms. The test generation engine 250 may be configured to automatically generate and execute test scripts for testing new functionality of one or more applications of cloud platform 270. The test generation engine 250 may also be configured to automatically generate detailed test case descriptions for manually executing test cases.

In an example, a test of new functionality is executed manually once and the performed actions are recorded. The user may define checks to be performed after each process step. Based on these defined checks, the test generation engine 250 automatically creates check routines for automated test execution. Additionally, the test generation engine 250 automatically creates text passages for manual execution. Still further, the test generation engine 250 automatically generates test artifacts. The proposed functionality can be used by persons without technical background (e.g., product owners (POs). This is advantageous, since a PO is usually very familiar with the end-to-end process under test. Now, the PO can easily include all required checks, just by selecting UI elements and by providing very basic information. This leads to a quality improvement of the tests in general. Furthermore, the artifacts are generated and therefore less error prone. The automated tests may be generated from a template, which increases the maintainability and reduces the total cost of ownership (TCO). In an example, the test case descriptions may be generated with the support of AI. For example, high quality texts can be generated, based on specifically designed prompts. Since the process is being recorded, it is less likely that important steps are forgotten to be described in the test case description. These advantages are beneficial for the tester's understanding of the test case description.

The one or more client devices 202 may include processor-based devices including, for example, a mobile device, a wearable apparatus, a personal computer, a workstation, an Internet-of-Things (IoT) appliance, and/or the like. The network 260 may be a wired network and/or wireless network including, for example, a public land mobile network (PLMN), a local area network (LAN), a virtual local area network (VLAN), a wide area network (WAN), the Internet, and/or the like.

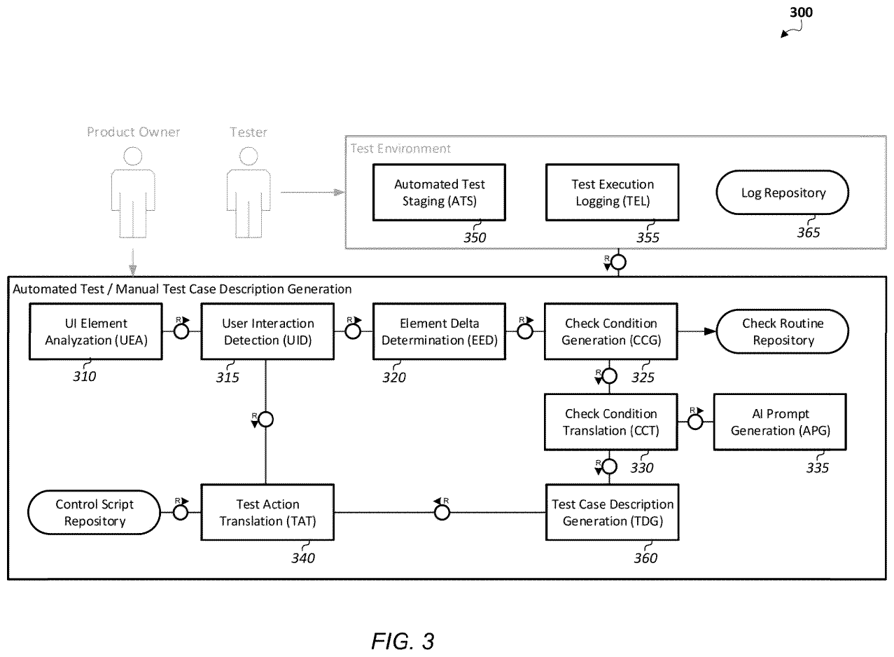

Referring now to FIG. 3, a block diagram of test generation and automated test execution functionality 300 is depicted, in accordance with one or more embodiments of the current subject matter. In some embodiments, test generation and automated test execution functionality 300 consists of different components as shown in FIG. 3. In an example, test generation engine 250 (of FIG. 2) includes the components of test generation and automated test execution functionality 300.

In an example, a proposed automated test generation and execution solution involves the recording of process steps. Next, test code and descriptive text are generated based on the recording of the process steps. Afterwards, a script may be generated based on the test code to enable these process steps to be executed automatically. The recording functionality may involve filling fields, pressing buttons on the user interface (UI), and the like. As an example, the Selenium driver may be used for recording the process steps. After the process steps are recorded, the corresponding checks may be generated for each process step, to avoid manual coding effort. Also, complete test case descriptions may be generated to avoid manual effort for writing.

If a new end-to-end test should be created, the corresponding process may be executed once manually. For simplicity reasons, it is assumed that a web-based application is used, which can be accessed through a web browser. However, in other embodiments, other approaches may be used for executing the corresponding process. The UI element analyzation (UEA) component 310 derives a list of elements displayed in the UI for a specific page. As an example, the UEA component 310 analyses the overview page of the “Manage Budget Documents” application. The UEA component 310 may find a list of header specific fields, two tables with item specific fields (sender and receiver), with corresponding labels, different buttons for processing the budget document, a log for system messages, and so on.

For each UI element, the UEA component 310 derives the technical identifier, the type of element (field, button, . . . ), the element's content (text, value, . . . ), and so on. Furthermore, the UEA component 310 determines relations, such as linkages between labels and fields. The user interaction detection (UID) component 315 supervises the communication of the user with the UI and its elements. As an example, the UID component 315 detects the filling of header and item specific fields on the overview page of the “Manage Budget Documents” application. The UID component 315 determines, which fields are filled with content. The UID component 315 determines the order of the fields to be filled, the content of the fields, and so on.

Parts of the UEA component 310 and the UID component 315 represent the previously mentioned recording functionality. Beyond this, the user now has the possibility to touch-up UI elements (e.g. through “CTRL”+left mouse click on the UI element) identified by the UEA component 310 and to provide additional information. As an example, the field for the company code as field of the budget document header might be filled with “1710” as usual but additionally, it is flagged as “FIX” by the user. This means, that the field for the company code on header level always must be filled with the fix value “1710”, for each execution of the test.

As another example, the field for the fund (account assignment on item level as part of the budget address for the sender) is also filled as usual on the UI but additionally, it is flagged as “F4” by the user. This means, it can be filled with any value from the F4 help if the test is executed. As additional example, the field for the description on header level can be flagged as “RAND” by the user, to indicate that this field can be filled randomly. This additional information is recorded together with the user interaction, by the UID component 315.

After each action, the user can touch-up UI elements to be checked afterwards. As an example, the UI element for the log containing the system messages might be selected. The element delta determination (EDD) component 320 observes changes of UI elements upon user interaction. As an example, the system might perform one or more validations and provide messages accordingly. These messages are appearing in the log on the UI. This is recognized as change of the content of the corresponding UI element. In this case, the EDD component 320 detects if a new message was raised by the system upon user interaction. The EDD component 320 also detects if a message was deleted.

Other examples include the system changing the text of UI elements, such as labels or buttons, the system changing the value(s) of one or more fields, and so on. With this, the influence from user interactions on UI elements can be determined. If the user selects an UI element after an action was performed, the changes determined by the EDD component 320 are displayed to the user. In case of a new error message (shown in the UI element of the log), additional details might be displayed in a new popup. In an example, the popup might be displayed after the user clicks on the UI element for the log or if the user clicks on the corresponding delta shown by the EDD component 320. In an example, the results of the EDD component 320 may be shown as a log in a new window located side-by-side to the browser session. An entry for the new message may be: “New message in the application log.” The user may click on this entry, so that a new pop-up appears, with additional information. In another example, a new pop-up may appear upon the user clicking on the original UI element (e.g., hotkey SHIFT+left mouse click).

As an example, there might be generic messages (messages with generic text) containing specific message parameters (to provide specific text). Information about these parameters might be shown in the popup. An example for such a generic message might be “Master data object X doesn't exist.” This message contains the parameter “X”. At runtime, this parameter is filled with “governmental fund”, to provide the specific message text “Master data ‘object governmental fund’ doesn't exist”. The generic message, its technical ID (e.g., combination of number and message class), the message parameter and its value might be shown within the popup as additional information.

The user can now provide information about the check to be performed. As an example, the EDD component 320 recognized a new message in the log. The user can now select the generic message from the popup and choose “CHECK” (e.g., via check box), to indicate that this change should be checked by the test. Furthermore, the user can select the message parameter, choose “COMPARE_TO” and then select the corresponding field to be compared with. As an example, the value of the message parameter should be compared to the content of the field for the fund on the sender item.

In another example, the text of a label is changed upon user interaction. This change is recognized by the EDD component 320. On clicking the label, the changes are displayed in a new popup. The user can now choose “CHECK” to indicate that this change should be checked by the test. Furthermore, the EDD component 320 detects navigations to other pages, detects the appearance of new UI elements, and so on. Here, no further information from the user is required. It is assumed that the navigation should happen and therefore will be checked. Additionally, the EDD component 320 may be enhanced with artificial intelligence (AI) capabilities, to improve the detection of changes.

The generation of the popup and the evaluation of the user's feedback is performed by the check condition generation (CCG) component 325. This information is later used by the check condition translation (CCT) component 330 to generate technical source code snippets for automated tests and/or human readable text fragments for test case descriptions.

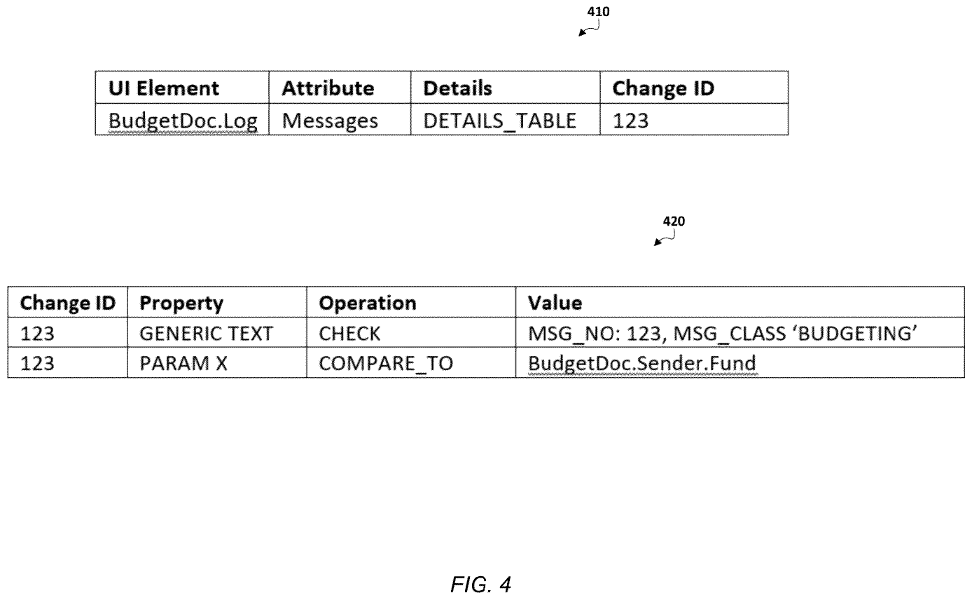

As an example, there might be a new error message to be checked. This error message may have one message parameter, containing the fund from the first sender item. The user may flag the changes on the UI accordingly. The result from the CCG component 325 may be as shown in tables 410 and 420 of FIG. 4. Table 410 includes the check information collected by the CCG component 325, based on the information provided by the user. Table 420 includes additional details for the check information collected by the CCG component 325, based on the information provided by the user.

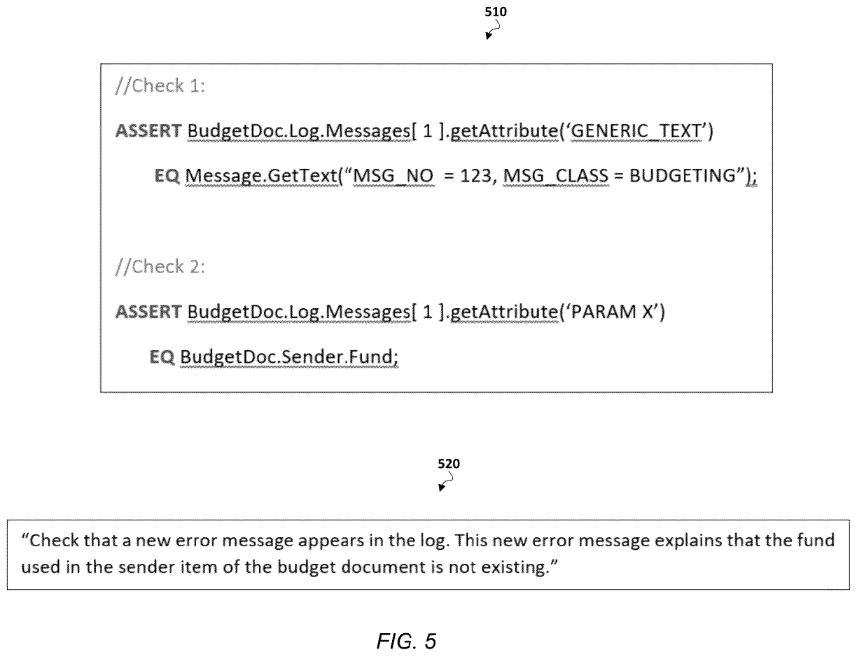

The CCT component 330 might consist of different libraries for different languages. In an example, two types of libraries exist. There are libraries for technical languages and for natural languages. For technical languages like programming languages, there might be a library for ABAP, another for JAVA, and so on. An example of pseudocode 510 generated by the CCT component 330 is shown in FIG. 5 for the checks of the given example, based on the information from the CCG component 325. The code may be included in routines or executable files, to be used in automated test processing. Different programming languages may be used. In an example, the checks may be generated from templates.

These source code snippets may be generated to be automatically executed later by the test environment. In an example, the source code snippets may be included in routines (e.g., check-routines), which are stored in the check-routine repository. If the recorded test steps are automatically re-executed by the test environment, the corresponding check-routines are provided with the current data (extracted from the browser session) and executed after the corresponding action was performed.

For natural languages, there may be a library for English, another for German, and so on. A large language model (LLM) may be used to generate human understandable and nicely readable phrases in the corresponding target language, using AI. The AI prompt generation (APG) component 335 is used by the CCT component 330 to communicate with the application programming interface (API) of an AI engine (not shown). The APG component 335 may generate the prompt (for the AI engine) from templates, based on the request from the CCT component 330. Box 520 of FIG. 5 shows an example of the human readable English text generated phrases that may be generated by the CCT component 330, based on the results from the CCG component 325.

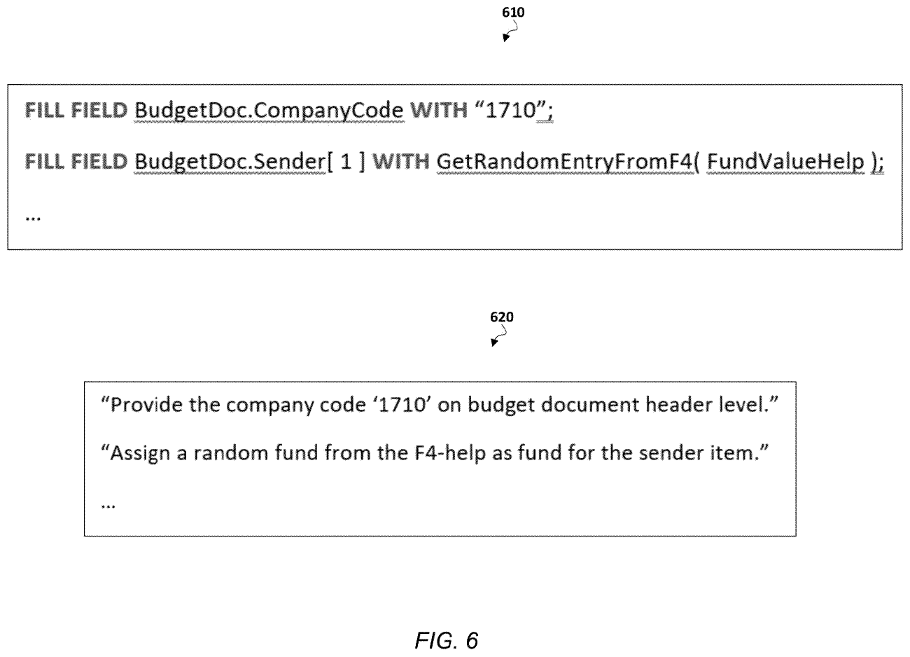

The user interactions together with additional information, observed by the UID are translated as well. This is done by the test action translation (TAT) component 340. Sticking to the given example (fix company code “1710”, arbitrary fund from the F4-help), the technical source code snippet shown in box 610 (of FIG. 6) and the corresponding human readable text shown in box 620 (of FIG. 6) may be generated. The technical source code is stored in the control script repository.

As shown in FIG. 6, box 610 includes an example of pseudocode for the actions performed during the test, generated by the TAT component 340. This information is used to control the browser during the automated test. In an example, a script language may be used to control the browser. Therefore, the language of the actions typically differs from the language of the checks. Box 620 includes example phrases generated by the TAT component 340 for the test case description for manual testing, to instruct the tester about the action to be performed during the test.

With this, both (actions and checks) can be translated into technical source code as well as into human readable text. With the technical source code, it is possible to generate complete tests including actions and their corresponding checks. It is noted that there may be two different types of technical source code. In other words, two different languages may be used to translate the actions and checks into technical source code. One type results from the TAT component 340. This type is executed to control the browser (similar to the former Selenium driver). In an example, a common script language (e.g., a kind of browser control language) may be employed. The other type of technical source code is generated by the CCT component 330 and is used to execute the checks after each action. Routines and/or executable files may be created here, which can be generated in any kind of programming language. Therefore, the automated test staging (ATS) component 350 may execute the actions (according to the results from the TAT component 340) on the one hand and execute the check-routines (according to the results from the CCT component 330) on the other hand. It is noted that this is merely illustrative of one example. In another example, the data from the CCT component 330 and the TAT component 340 is translated into a single program, (e.g., a single Java program).

Afterwards, runtime information about the automated test, including the results from the check-routines, may be persisted in the log repository 365, by the test execution logging (TEL) component 355. For test case descriptions for manual execution, the information from the TAT component 340 and the CCT component 330 may be combined into a single document. Here, the resulting document combines information about actions and checks, which may be translated to the same natural language. This is done by the test case description generation (TDG) component 360. The TDG component 360 can automatically include screenshots and additional information. Also, the TDG component 360 might use techniques of AI to create perfectly cut screenshots after each user interaction. In conclusion, the proposed functionality enables a user to record processes and to generate automated test and test case descriptions for manual execution. The generated artifacts include information about the test steps, including the actions and the checks to be performed for each step.

In an example, a new end-to-end test may be created for the “Manage Budget Documents” application. The “Manage Budget Documents” application is used to create new budget documents. During the process under test, a new budget document is created to transfer budget from one or more sender budget addresses to one or more receiver budget addresses. A budget address is a combination of account assignments. Each account assignment is represented by a master data object.

Senders and receivers are reflected by budget document items. All high-level information and administrative data is reflected by the budget document header. The budget document resulting from the transfer process is called a budget transfer document. Various validations are executed during the overall posting process of the budget document: (1) At least one sender must exist. (2) At least one receiver must exist. (3) All budgeting relevant account assignments must be provided and the corresponding master data objects must exist. (4) Enough budget must be available for the sender budget address.

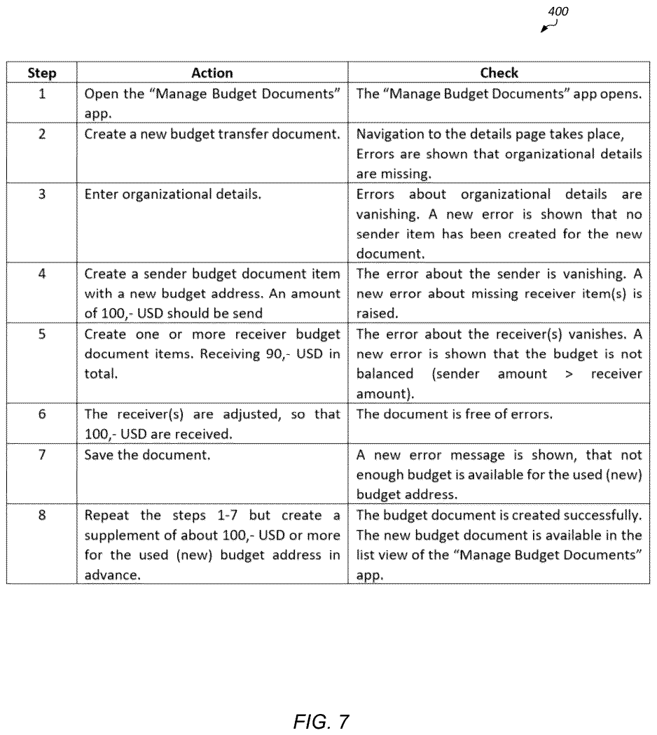

Table 700 of FIG. 7 shows a list of steps and checks to be performed during the execution of the new end-to-end test. This is just a simple example, but the same list of steps also may be applied for complex scenarios.

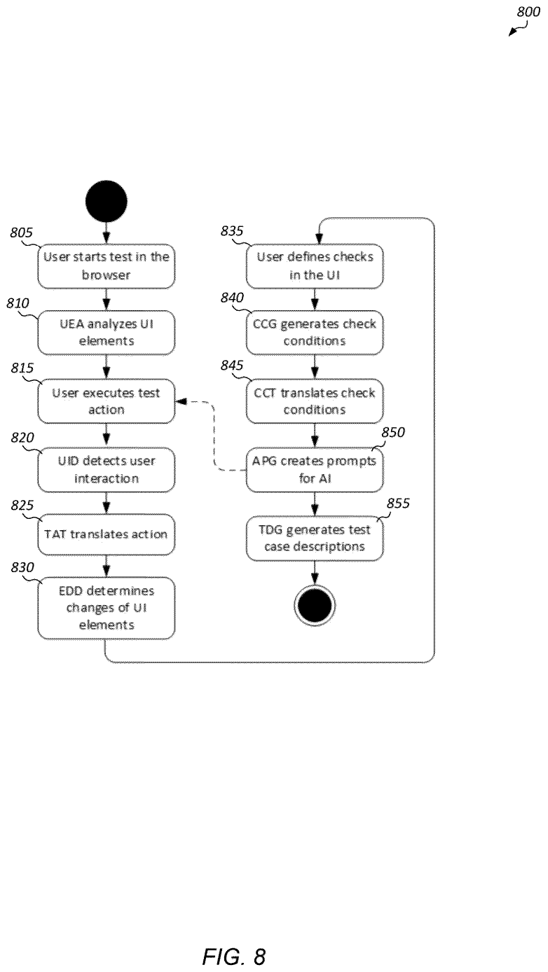

Turning now to FIG. 8, a process for automatic test generation is depicted, in accordance with one or more embodiments of the current subject matter. At the beginning of the process, a user starts a test in a browser (block 805). Next, a UEA component (e.g., UEA component 310 of FIG. 3) analyzes user interface (UI) elements (block 810). Then, the user executes a test action (block 815).

Next, the UID component (e.g., UID component 315) detects a user interaction (block 820). Then, the TAT component (e.g., TAT component 340) translates the action (block 825). Next, the EDD component (e.g., EDD component 320) determines changes of UI elements (block 830). Also, the user defines checks in the UI (block 835). Then, based on the user-defined checks, the CCG component (e.g., CCG component 325) generates check conditions (block 840). Next, the CCT component (e.g., CCT component 330) translates the check conditions (block 845). Then, the APG component (e.g., APG component 335) creates prompts for an artificial intelligence (AI) model (block 850). If the user executes more test actions, then method 800 returns to block 815. Otherwise, if the user has finished executing test actions, then the TDG component (e.g., TDG component 360) generates test case descriptions (block 855). After block 855, method 800 may end.

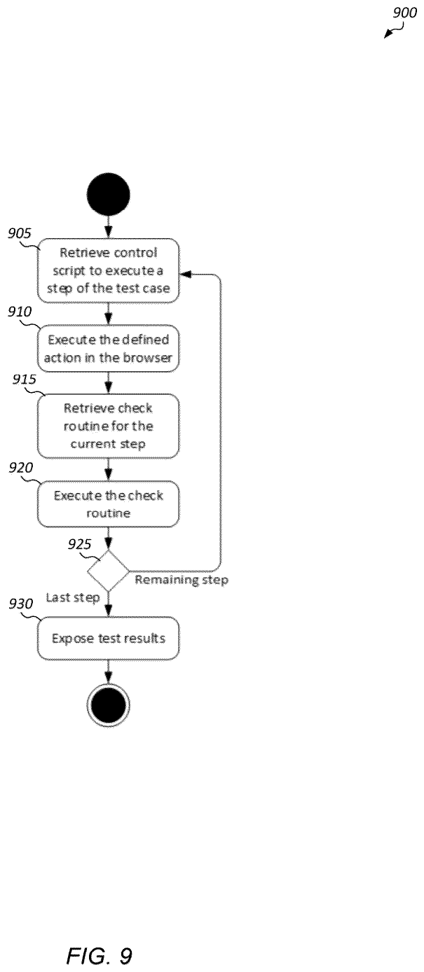

Referring now to FIG. 9, a process for automated test staging is depicted, in accordance with one or more embodiments of the current subject matter. At the beginning of the process, a control script is retrieved to execute a step of the test case (block 905). Next, the defined action is executed in the browser (block 910). Then, the check routine is retrieved for the current step (block 915).

Next, the check routine is executed (block 920). If there are any remaining steps (conditional block 925, “remaining step” leg), then method 900 returns to block 905. Otherwise, if there are no remaining steps (conditional block 925, “last step” leg), then test results are exposed (block 930). After block 930, method 900 may end.

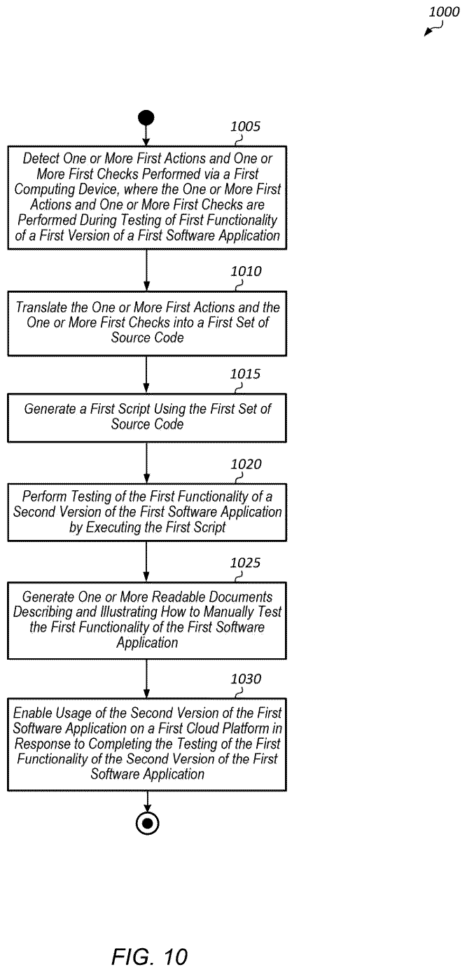

Turning now to FIG. 10, a process for enabling automatic testing of functionality of a software application is depicted, in accordance with one or more embodiments of the current subject matter. A test generation engine (e.g., test generation engine 250) detects one or more first actions and one or more first checks performed via a first computing device, where the one or more first actions and one or more first checks are performed during testing of first functionality of a first version of a first software application (block 1005). Next, the test generation engine translates the one or more first actions and the one or more first checks into a first set of source code (block 1010). Then, the test generation engine generates a first script using the first set of source code (block 1015).

Next, at a later point in time, the test generation engine performs testing of the first functionality of a second version of the first software application by executing the first script (block 1020). Also, the test generation engine generates one or more readable documents describing and illustrating how to manually test the first functionality of the first software application (block 1025). For example, the one or more readable documents may include one or more UI screenshots, a step-by-step explanation of the testing, and/or other descriptive elements. Then, the test generation engine enables usage of the second version of the first software application on a first cloud platform in response to completing the testing of the first functionality of the second version of the first software application (block 1030). In other words, the second version of the first software application may be accessed by one or more users via the first cloud platform, allowing the one or more users to execute the second version of the first software application. After block 1030, method 1000 may end.

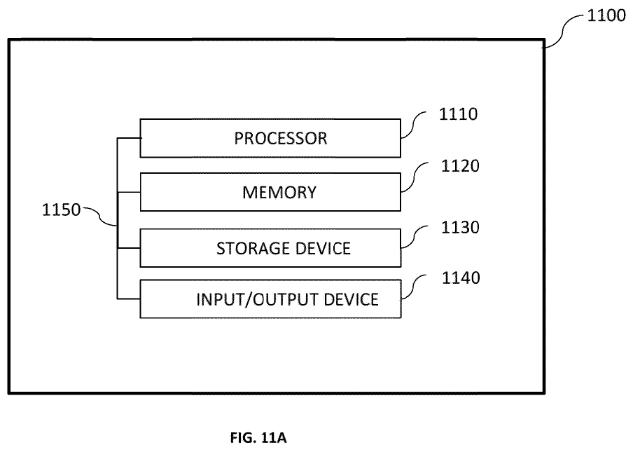

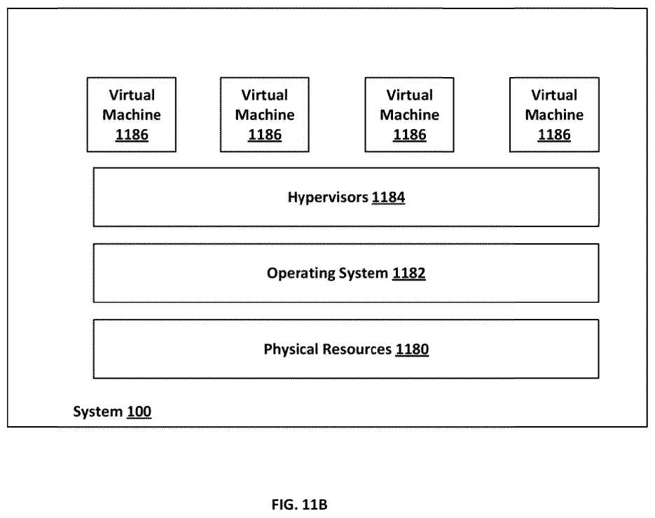

In some implementations, the current subject matter may be configured to be implemented in a system 1100, as shown in FIG. 11A. The system 1100 may include a processor 1110, a memory 1120, a storage device 1130, and an input/output device 1140. Each of the components (e.g., the processor 1110, the memory 1120, the storage device 1130, the I/O device 1140) may be interconnected using a system bus 1150. The processor 1110 may be configured to process instructions for execution within the system 1100. In some implementations, the processor 1110 may be a single-threaded processor. In alternate implementations, the processor 1110 may be a multi-threaded processor. The processor 1110 may be further configured to process instructions stored in the memory 1120 or on the storage device 1130, including receiving or sending information through the input/output device 1140. The memory 1120 may store information within the system 1100. In some implementations, the memory 1120 may be a computer-readable medium. In alternate implementations, the memory 1120 may be a volatile memory unit. In yet some implementations, the memory 1120 may be a non-volatile memory unit. The storage device 1130 may be capable of providing mass storage for the system 1100. In some implementations, the storage device 1130 may be a computer-readable medium. In alternate implementations, the storage device 1130 may be a floppy disk device, a hard disk device, an optical disk device, a tape device, non-volatile solid state memory, or any other type of storage device. The input/output device 1140 may be configured to provide input/output operations for the system 1100. In some implementations, the input/output device 1140 may include a keyboard and/or pointing device. In alternate implementations, the input/output device 1140 may include a display unit for displaying graphical user interfaces.

FIG. 11B depicts an example implementation of the system 100 (of FIG. 1). The system 100 may be implemented using various physical resources 1180, such as at least one or more hardware servers, at least one storage, at least one memory, at least one network interface, and the like. The system 100 may also be implemented using infrastructure, as noted above, which may include at least one operating system 1182 for the physical resources 1180 and at least one hypervisor 1184 (which may create and run at least one virtual machine 1186). For example, each multitenant application may be run on a corresponding virtual machine 1186.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable storage medium” refers to any computer program product, apparatus and/or device, such as for example magnetic discs, optical disks, memory, and Programmable Logic Devices (PLDs), used to provide machine instructions and/or data to a programmable processor, including a machine-readable storage medium that receives program instructions as a machine-readable signal. The term “machine-readable signal” refers to any signal used to provide machine instructions and/or data to a programmable processor. The machine-readable storage medium can store such program instructions non-transitorily, such as for example as would a non-transient solid state memory or a magnetic hard drive or any equivalent storage medium. The machine-readable storage medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system comprising: at least one processor; and at least one memory storing instructions that, when executed by the at least one processor, cause operations comprising: detecting one or more first actions and one or more first checks performed via a first computing device, wherein the one or more first actions and one or more first checks are performed during testing of first functionality of a first version of a first software application; translating the one or more first actions and one or more first checks into a first set of source code; generating a first script with the first set of source code; performing testing of the first functionality of a second version of the first software application by executing the first script; and enabling usage of the second version of the first software application on a first cloud platform in response to completing the testing of the first functionality of a second version of the first software application.

Example 2: The system of Example 1, wherein the operations further comprise generating one or more human readable documents illustrating how to test the first functionality of the first version and the second version of the first software application.

Example 3: The system of any of Examples 1-2, wherein the operations further comprise: detecting one or more second actions and one or more second checks performed via the first computing device, wherein the one or more second actions and one or more second checks occur during testing of second functionality of the first version of the first software application; translating the one or more second actions and one or more second checks into a second set of source code; generating a second script with the second set of source code; and performing testing of the second functionality of the second version of the first software application by executing the second script.

Example 4: The system of any of Examples 1-3, wherein the first software application executes on a first cloud platform.

Example 5: The system of any of Examples 1-4, wherein the one or more first actions comprise navigation from a first page to a second page, and wherein the one or more first checks comprise checking that the navigation occurs from the first page to the second page.

Example 6: The system of any of Examples 1-5, wherein the operations further comprise detecting one or more elements marked as check relevant.

Example 7: The system of any of Examples 1-6, wherein the operations further comprise: deriving one or more check conditions for the one or more elements marked as check relevant; translating the one or more check conditions into one or more technical source code fragments; and including the one or more technical source code fragments in the first script.

Example 8: The system of any of Examples 1-7, wherein the first software application is a database application.

Example 9: The system of any of Examples 1-8, wherein the first software application is an enterprise resource planning (ERP) application.

Example 10: The system of any of Examples 1-9, wherein enabling usage of the second version of the first software application allows one or more users to execute the second version of the first software application.

Example 11: A computer-implemented method comprising: detecting one or more first actions and one or more first checks performed via a first computing device, wherein the one or more first actions and one or more first checks are performed during testing of first functionality of a first version of a first software application; translating the one or more first actions and one or more first checks into a first set of source code; generating a first script with the first set of source code; performing testing of the first functionality of a second version of the first software application by executing the first script; and enabling usage of the second version of the first software application on a first cloud platform in response to completing the testing of the first functionality of a second version of the first software application.

Example 12: The computer-implemented method of Example 11, further comprising generating one or more human readable documents illustrating how to test the first functionality of the first version and the second version of the first software application.

Example 13: The computer-implemented method of any of Examples 11-12, further comprising: detecting one or more second actions and one or more second checks performed via the first computing device, wherein the one or more second actions and one or more second checks occur during testing of second functionality of the first version of the first software application; translating the one or more second actions and one or more second checks into a second set of source code; generating a second script with the second set of source code; and performing testing of the second functionality of the second version of the first software application by executing the second script.

Example 14: The computer-implemented method of any of Examples 11-13, wherein the first software application executes on a first cloud platform.

Example 15: The computer-implemented method of any of Examples 11-14, wherein the one or more first actions comprise navigation from a first page to a second page, and wherein the one or more first checks comprise checking that the navigation occurs from the first page to the second page.

Example 16: The computer-implemented method of any of Examples 11-15, further comprising detecting one or more elements marked as check relevant.

Example 17: The computer-implemented method of any of Examples 11-16, further comprising: deriving one or more check conditions for the one or more elements marked as check relevant; translating the one or more check conditions into one or more technical source code fragments; and including the one or more technical source code fragments in the first script.

Example 18: The computer-implemented method of any of Examples 11-17, wherein the first software application is a database application.

Example 19: The computer-implemented method of any of Examples 11-18, wherein the first software application is an enterprise resource planning (ERP) application.

Example 20: A non-transitory computer readable storage medium storing instructions, which when executed by at least one data processor, result in operations comprising: detecting one or more first actions and one or more first checks performed via a first computing device, wherein the one or more first actions and one or more first checks are performed during testing of first functionality of a first version of a first software application; translating the one or more first actions and one or more first checks into a first set of source code; generating a first script with the first set of source code; performing testing of the first functionality of a second version of the first software application by executing the first script; and enabling usage of the second version of the first software application on a first cloud platform in response to completing the testing of the first functionality of a second version of the first software application.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system comprising:
at least one processor; and
at least one memory storing instructions that, when executed by the at least one processor, cause operations comprising:
detecting one or more first actions and one or more first checks performed via a first computing device, wherein the one or more first actions and one or more first checks are performed during testing of first functionality of a first version of a first software application;
translating the one or more first actions and one or more first checks into a first set of source code;
generating a first script with the first set of source code;
performing testing of the first functionality of a second version of the first software application by executing the first script; and
enabling usage of the second version of the first software application on a first cloud platform in response to completing the testing of the first functionality of the second version of the first software application.

2. The system of claim 1, wherein the operations further comprise generating one or more human readable documents illustrating how to test the first functionality of the first version and the second version of the first software application.

3. The system of claim 1, wherein the operations further comprise:
detecting one or more second actions and one or more second checks performed via the first computing device, wherein the one or more second actions and one or more second checks occur during testing of second functionality of the first version of the first software application;
translating the one or more second actions and one or more second checks into a second set of source code;
generating a second script with the second set of source code; and
performing testing of the second functionality of the second version of the first software application by executing the second script.

4. The system of claim 1, wherein the first software application executes on a first cloud platform.

5. The system of claim 1, wherein the one or more first actions comprise navigation from a first page to a second page, and wherein the one or more first checks comprise checking that the navigation occurs from the first page to the second page.

6. The system of claim 1, wherein the operations further comprise detecting one or more elements marked as check relevant.

7. The system of claim 6, wherein the operations further comprise:
deriving one or more check conditions for the one or more elements marked as check relevant;
translating the one or more check conditions into one or more technical source code fragments; and
including the one or more technical source code fragments in the first script.

8. The system of claim 1, wherein the first software application is a database application.

9. The system of claim 1, wherein the first software application is an enterprise resource planning (ERP) application.

10. The system of claim 1, wherein enabling usage of the second version of the first software application allows one or more users to execute the second version of the first software application.

11. A computer-implemented method comprising:
detecting one or more first actions and one or more first checks performed via a first computing device, wherein the one or more first actions and one or more first checks are performed during testing of first functionality of a first version of a first software application;
translating the one or more first actions and one or more first checks into a first set of source code;
generating a first script with the first set of source code;
performing testing of the first functionality of a second version of the first software application by executing the first script; and
enabling usage of the second version of the first software application on a first cloud platform in response to completing the testing of the first functionality of the second version of the first software application.

12. The computer-implemented method of claim 11, further comprising generating one or more human readable documents illustrating how to test the first functionality of the first version and the second version of the first software application.

13. The computer-implemented method of claim 11, further comprising:
detecting one or more second actions and one or more second checks performed via the first computing device, wherein the one or more second actions and one or more second checks occur during testing of second functionality of the first version of the first software application;
translating the one or more second actions and one or more second checks into a second set of source code;
generating a second script with the second set of source code; and
performing testing of the second functionality of the second version of the first software application by executing the second script.

14. The computer-implemented method of claim 11, wherein the first software application executes on a first cloud platform.

15. The computer-implemented method of claim 11, wherein the one or more first actions comprise navigation from a first page to a second page, and wherein the one or more first checks comprise checking that the navigation occurs from the first page to the second page.

16. The computer-implemented method of claim 11, further comprising detecting one or more elements marked as check relevant.

17. The computer-implemented method of claim 16, further comprising:
deriving one or more check conditions for the one or more elements marked as check relevant;
translating the one or more check conditions into one or more technical source code fragments; and
including the one or more technical source code fragments in the first script.

18. The computer-implemented method of claim 11, wherein the first software application is a database application.

19. The computer-implemented method of claim 11, wherein the first software application is an enterprise resource planning (ERP) application.

20. A non-transitory computer readable storage medium storing instructions, which when executed by at least one data processor, result in operations comprising:
detecting one or more first actions and one or more first checks performed via a first computing device, wherein the one or more first actions and one or more first checks are performed during testing of first functionality of a first version of a first software application;
translating the one or more first actions and one or more first checks into a first set of source code;
generating a first script with the first set of source code;
performing testing of the first functionality of a second version of the first software application by executing the first script; and
enabling usage of the second version of the first software application on a first cloud platform in response to completing the testing of the first functionality of the second version of the first software application.
